(19) United States
(12) Patent Application Publication
(10) Pub. No.: US 2019/0317919 A1
(43) Pub. Date: Oct. 17, 2019

(54) APPARATUS AND METHOD FOR CONVERTING METADATA

(71) Applicant: ELECTRONICS AND TELECOMMUNICATIONS RESEARCH INSTITUTE, Daejeon (KR)

(72) Inventors: Kyoung Hyun PARK, Daejeon (KR); Hee Sun WON, Daejeon (KR)

(21) Appl. No.: 16/249,985

(22) Filed: Jan. 17, 2019

(30) Foreign Application Priority Data
Apr. 11, 2018 (KR) 10-2018-0042385

(51) Int. Cl. G06F 16/16; G06F 16/14

(52) U.S. Cl. CPC G06F 16/164; G06F 16/14

(57) ABSTRACT

The apparatus for converting metadata sets a standard protocol model of metadata to be applied, collects metadata of a distribution platform that is a collection target, performs mapping between the collected metadata and the standard protocol model, and converts mapped metadata to a file format for metadata exchange.

### CROSS-REFERENCE TO RELATED APPLICATION

This application claims priority to and the benefit of Korean Patent Application No. 10-2018-0042385 filed in the Korean Intellectual Property Office on Apr. 11, 2018, the entire content of which is incorporated herein by reference.

### BACKGROUND OF THE INVENTION

### 1. Field of the Invention

The present invention relates to an apparatus and method for converting metadata, and more particularly, to an apparatus and method for converting metadata for metadata interchange in a data distribution environment.

### 2. Description of Related Art

With the recent development of artificial intelligence technology, data is increasingly recognized as an important resource, and thus countries around the world have established and implemented an open data policy to create a variety of public data-based business opportunities. In addition, a data distribution platform is spreading and developing as a solution to effectively store, manage and share large-capacity public data across all sectors of society.

Public data is a vast amount of data generated and managed by public agencies, and refers to a vast amount of data across all sectors of society, from weather and geographic information to transportation and food. An open data distribution platform is spreading and developing as software for effectively sharing and utilizing public data. A representative open source platform is CKAN (Comprehensive Knowledge Archive Network) and DKAN, and a commercial platform is Socrata.

The open data platform manages data through a data catalog and provides various search functions. Also, since information exchange and search with other platforms is performed through the data catalog, the standardization of the data catalog is one of the most important factors in the utilization of the open data platform.

The most representative technology among data catalog standard technologies is DCAT (Data Catalog Vocabulary), which is a metadata standard for integration and management of data on the web. DCAT is a W3C standard for providing interoperability between catalog data existing on the web. It is defined in RDF (Resource Description Framework) format such that metadata may be read from various data sources on the web to access and utilize data.

Because of its flexible scalability, DCAT is being applied to many open data platforms such as CKAN, DKAN, and CKRATA and is actually being utilized for data interworking in many public data portals such as data.gov and data.gov.uk. DCAT consists of three main classes of Catalog, DataSet, and Distribution, and one important class of Distribution.

CKAN, one of the open data platforms, shares metadata among CKANs through CKAN harvesting. Supporting DCAT harvesting also allows data to be shared with other platforms that support DCAT, even if it is not a CKAN platform.

In general, data distribution platforms utilize existing platforms such as CKAN as they are, but there are many cases in which they are developed by themselves by requirements or existing platforms are developed through modification and expansion. In this case, there is a problem that metadata data may not be interchanged between data platforms.

### SUMMARY OF THE INVENTION

The present invention has been made in an effort to provide an apparatus and method for converting metadata having advantages of enabling metadata interchange between platforms.

An exemplary embodiment of the present invention provides a method for converting metadata in an apparatus for converting metadata. The method includes setting a standard protocol model of the metadata to be applied, collecting metadata of a distribution platform that is a collection target, performing mapping between the collected metadata and the standard protocol model, and converting the mapped metadata into a file format for metadata exchange.

The setting may include selecting a DCAT (Data Catalog Vocabulary) as a standard protocol.

The mapping may include extracting schema information from the collected metadata, changing the standard protocol model to a relational model, and mapping the schema information of the metadata and the relational model.

The mapping of the schema information of the metadata and the relational model may include mapping if a corresponding field exists in the schema information of the metadata based on the relational model.

The extracting of the schema information may include extracting the schema and metadata information using at least one of methods of accessing a database directly, using a REST API that is accessible to the database, and accessing a file storing the metadata information.

The converting may include setting an end point and determining a file format of the metadata.

The method may further include distributing the metadata converted to the file format.

Another embodiment of the present invention provides an apparatus for converting metadata of a data distribution platform. The apparatus may include a processor configured to collect metadata of a distribution platform that is a collection target, perform mapping between standard protocol models of the collected metadata and metadata to be applied, and then convert the mapped metadata into a file format for metadata exchange, and an input/output interface configured to exchange the metadata of the file format.

The standard protocol model may include a DCAT (Data Catalog Vocabulary).

The processor may be configured to extract schema information from the collected metadata, change the standard protocol model to a relational model, and then map if a corresponding field exists based on the relational model.

The processor may be configured to extract the schema information using at least one of methods of accessing a database directly, using a REST API that is accessible the database, and accessing a file storing the metadata information.

The processor may be configured to determine an end point for determining an output format of mapped metadata and then determine a file format of the mapped metadata.

### BRIEF DESCRIPTION OF THE DRAWINGS

FIG. 1 shows an example of a method of collecting metadata between data distribution platforms.

FIG. 2 illustrates a mapping method between metadata and DCAT in an apparatus for converting metadata according to an embodiment of the present invention.

FIG. 3 illustrates a method of extracting metadata schema information in an apparatus for converting metadata according to an embodiment of the present invention.

FIG. 4 illustrates a method of extracting metadata schema information in an apparatus for converting metadata according to another embodiment of the present invention.

FIG. 5 illustrates a method of extracting metadata schema information in an apparatus for converting metadata according to another embodiment of the present invention.

FIG. 6 illustrates a method of extracting a schema of a data distribution platform to generate a DCAT-based RDF file according to an embodiment of the present invention.

FIG. 7 shows an interface mapping between metadata and a DCAT according to an embodiment of the present invention.

FIG. 8 shows a method of managing an RDF file in an apparatus for converting metadata according to an embodiment of the present invention.

FIG. 9 shows an apparatus for converting metadata according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising”, will be understood to imply the inclusion of stated elements but not the exclusion of any other elements.

Hereinafter, an apparatus and a method for converting metadata according to an embodiment of the present invention in detail with reference to the drawings.

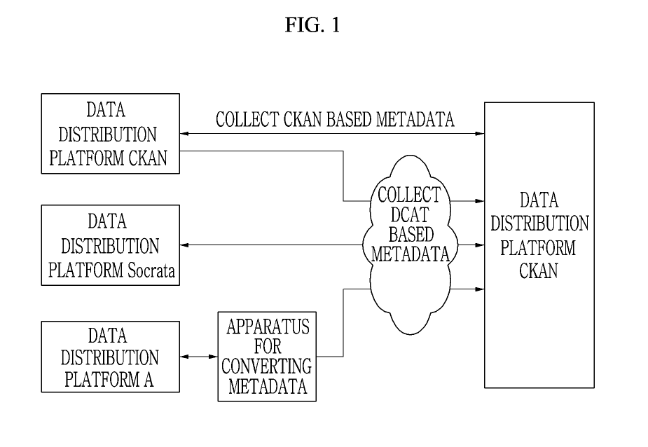

FIG. 1 shows an example of a method of collecting metadata between data distribution platforms.

As shown in FIG. 1, collection of the metadata with CKAN-CKAN may be basically performed using a data collection function provided by CKAN.

CKAN supports DCAT, which is one of the metadata international standards. Thus, the metadata may be collected through other platforms that support DCAT, for example, Socrata and DCAT.

However, Data store, which is one of the representative data distribution platforms in Korea, does not support DCAT because it is a platform developed by itself. Therefore, a metadata exchange is impossible between a CKAN platform and Data store.

Therefore, an apparatus for converting metadata may be placed between Data store and CKAN to enable metadata collection between Data store and CKAN.

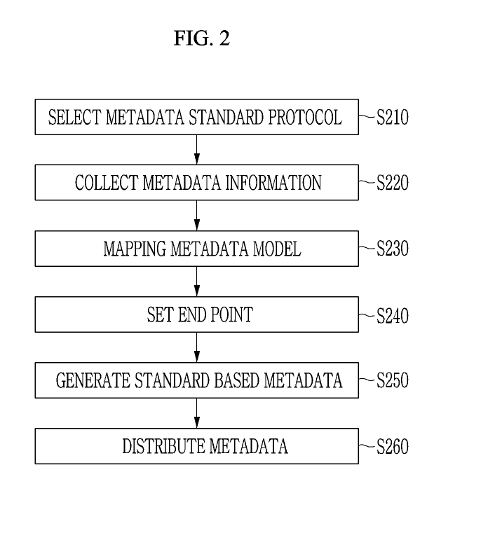

FIG. 2 illustrates a mapping method between metadata and DCAT in an apparatus for converting metadata according to an embodiment of the present invention.

Referring to FIG. 2, the apparatus for converting the metadata selects a metadata standard to be applied first in order to convert the metadata into a format for data exchange. An embodiment of the present invention is described based on DCAT which is one of the metadata international standards.

The apparatus for converting the metadata collects metadata information of a distribution platform that is a collection target after setting a standard protocol of the metadata. In order to collect the metadata information of a target platform, the metadata information may be collected using a method of directly logging in and accessing a database, a method of accessing a database using REST API (Representational State Transfer Application Programming Interface), a method of accessing a file where the metadata information is stored, etc.

The apparatus for converting the metadata performs mapping between the metadata and a DCAT model after collecting the metadata information. The apparatus for converting the metadata extracts schema information from the collected metadata for mapping, provides the schema information to a user, and changes the DCAT model to a relational model to provide the relational model to the user. Basically, in the DCAT model, a class name is converted to a table name and a field name in a class is converted to a column name in a table.

The apparatus for converting the metadata performs mapping on the schema information of the metadata and relational data model of DCAT. At this time, the apparatus for converting the metadata determines whether the corresponding field is included in the collected schema information based on the relational model of DCAT.

When mapping is done, a part of the metadata of the platform is mapped and another part is not mapped. At this time, data collection targets are limited to mapped metadata.

The apparatus for converting the metadata sets an end point to determine an output type after schema mapping. The end point supports two types of catalogs and data sets. A data set describes a metadata set based on a set of data. A catalog is a form of describing information of a plurality of data sets.

The apparatus for converting the metadata converts the metadata into a file for the metadata exchange after setting the end point. The file format supports JSON (JavaScript Object Notation) and RDF (Resource Description Framework) file format.

Next, the apparatus for converting the metadata distributes the converted metadata. The distribution here includes a function that stores the metadata in a location accessible from other data platforms and, if a specific platform is selected, delivers metadata source information to the corresponding platform.

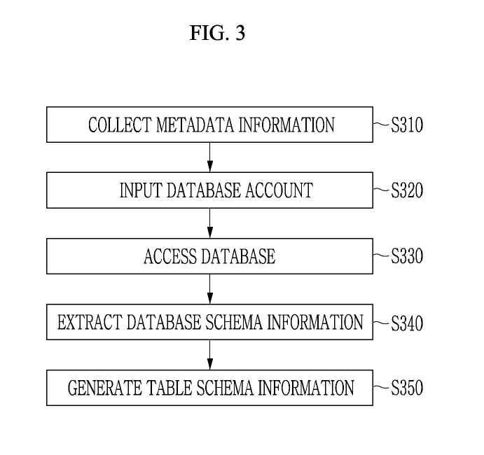

FIG. 3 illustrates a method of extracting metadata schema information in an apparatus for converting metadata according to an embodiment of the present invention.

Referring to FIG. 3, the apparatus for converting the metadata collects metadata information and then extracts the schema information from the collected metadata, and may use a method of extracting the schema information by directly accessing a database as a method of extracting the metadata schema information.

The apparatus for converting the metadata accesses a database account and then extracts database schema information.

Next, the apparatus for converting the metadata generates table schema information.

As such, the method of extracting schema information by directly accessing the database may be performed by a database administrator of the corresponding platform.

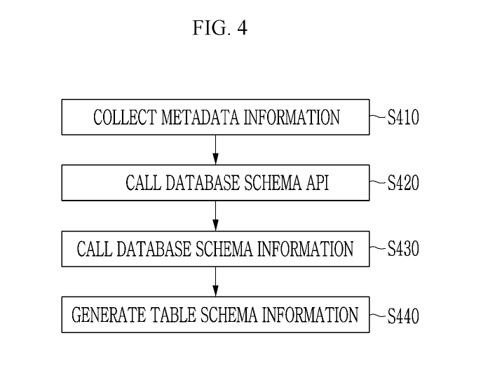

FIG. 4 illustrates a method of extracting metadata schema information in an apparatus for converting metadata according to another embodiment of the present invention.

Referring to FIG. 4, as the method of extracting the metadata schema information, a method of using a REST API that is accessible a database may be used.

The apparatus for converting the metadata collects metadata information, then calls a database schema API that goes public in a platform to extract schema information from the collected metadata, and accesses the database using the database schema API.

Next, the apparatus for converting the metadata extracts database schema information and generates table schema information.

This method may be used when a method shown in FIG. 3 is difficult to use due to a security problem.

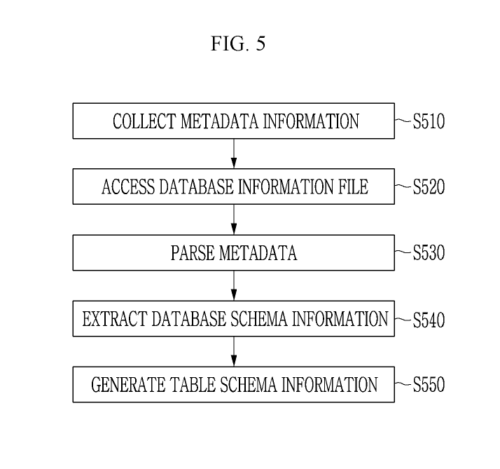

FIG. 5 illustrates a method of extracting metadata schema information in an apparatus for converting metadata according to another embodiment of the present invention.

Referring to FIG. 5, as the method of extracting the metadata schema information, a method of accessing a file storing metadata information instead of a database may be used.

The apparatus for converting the metadata collects metadata information, then accesses the file storing the metadata information, and parses the metadata.

Next, the apparatus for converting the metadata extracts database schema information and generates table schema information.

This method is a method of using only publicly available information and generating the information as a file to provide the schema information when the corresponding platform does not support an API that provides database schema.

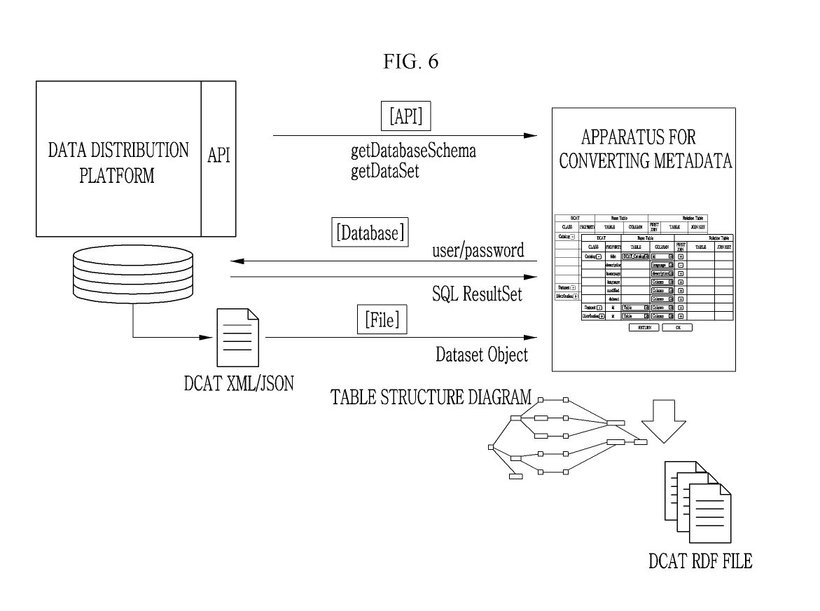

FIG. 6 illustrates a method of extracting a schema of a data distribution platform to generate a DCAT-based RDF file according to an embodiment of the present invention.

Referring to FIG. 6, an apparatus for converting metadata reads schema and metadata information using methods described in FIGS. 3 to 5.

A method of using an API has largely two types of API functions. There are an API that reads schema information and an API that reads metadata information of the corresponding schema. Therefore, the apparatus for converting the metadata first reads the schema information of the platform and allows mapping between the metadata of the platform and DCAT. After mapping is completed, the apparatus for converting the metadata reads the metadata through the API that reads the metadata information, converts the metadata into a mapped DCAT metadata format, and generates and stores data in the RDF file format.

A method of using a database is to access the database directly and read database schema and metadata information. In this case, the method may be performed by a database administrator of the data distribution platform and the apparatus for converting the metadata may access directly the database by inputting a username and a password.

Next, a method of using a file may be used when it is not allowed to access a database of a data distribution platform from the outside.

The data distribution platform does not go public its own database but extracts only information that it wants to go public and generates and provides the information as a file. Therefore, the file stores and provides database schema information and metadata information that are wanted to go public in an XML format.

In this way, the apparatus for converting the metadata reads the schema and metadata information using at least one of the methods using API, database and file. Next, the apparatus for converting the metadata maps between the metadata and a DCAT and converts and stores the mapped DCAT metadata into an RDF file.

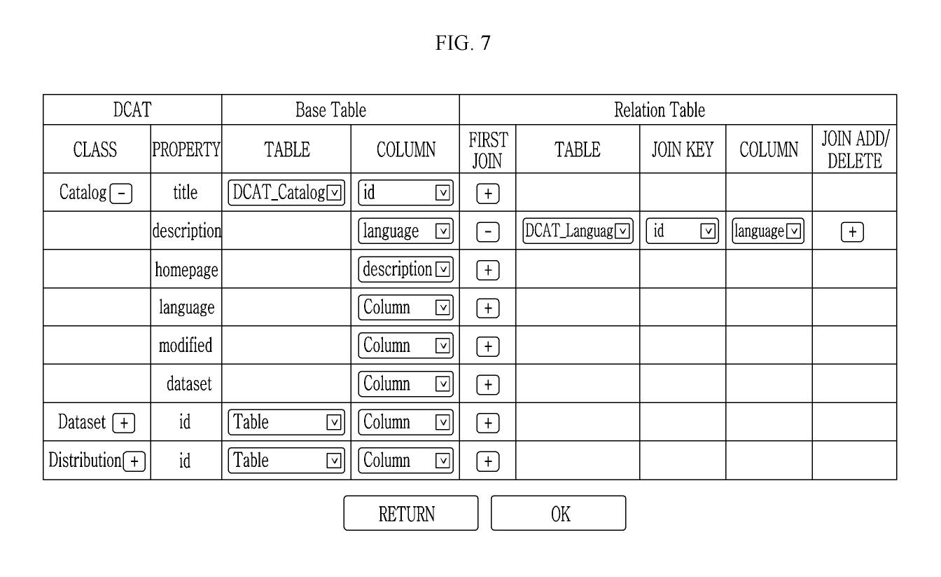

FIG. 7 shows an interface mapping between metadata and a DCAT according to an embodiment of the present invention, in which a left side shows DCAT class and field, and a right side shows database schema and relation information of a data distribution platform.

Referring to FIG. 7, mapping between the metadata and the DCAT is not mapped to all DCAT fields but only when there is a schema corresponding to the data distribution platform. For mapping, first a class of the DCAT to be mapped in a DCAT panel on the left side and a field of the corresponding class are selected. Then the corresponding database table is selected in a right panel. When the corresponding table is selected, a list of columns of the corresponding table appears in a column panel and the corresponding one of the columns is selected.

Basically, to map the table and the column of a database mapped to the DCAT class and field, column information in the table of the database actually stores data, but has an ID value or a code value through relation. In this case, the corresponding value needs to retrieve through a join operation. This function is performed by a left relation panel.

If two tables have relations and may read data through a single join operation, a column to be mapped to the table having the relation is set in a database panel, and a column having the relation with the table corresponding to the database panel is mapped to a relation panel. Finally, a column we want to search is set in a view panel to read the corresponding value.

In practice, since a relation between tables may require one or more join operations, a user interface may provide one or more relations between tables.

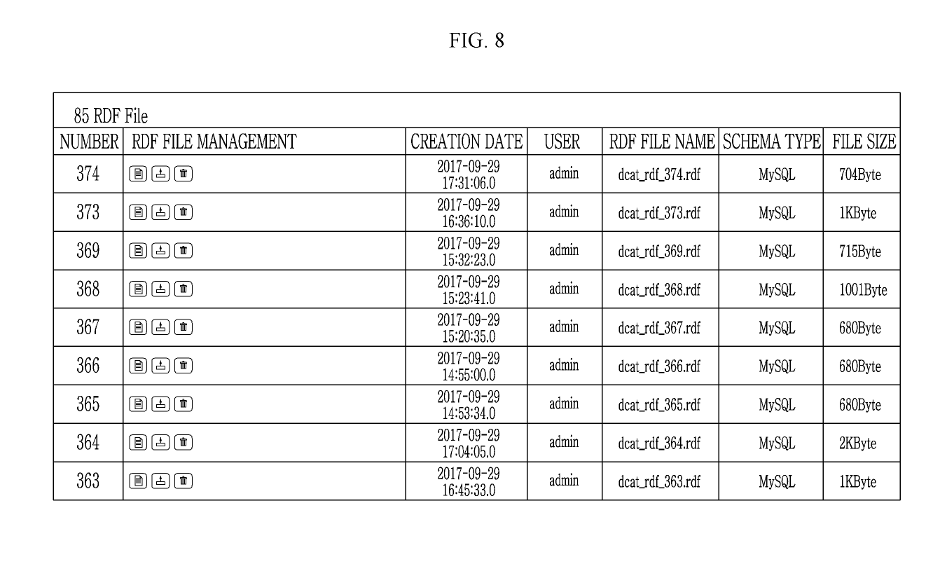

FIG. 8 shows a method of managing an RDF file in an apparatus for converting metadata according to an embodiment of the present invention.

As shown in FIG. 8, the apparatus for converting the metadata stores generated RDF files in a RDF store. The RDF file may be managed with information such as an ID of a user who created the file, an RDF file name, a creation date, a file size, and a type of database accessed.

The apparatus for converting the metadata may perform distribution in a RDF file list. Distribution here refers to providing a path for other platforms to access the RDF file or providing RDF information to the corresponding platform.

Therefore, when the apparatus for converting the metadata performs a distribution function, the RDF file may be stored in a location accessible by a HTTP protocol and the RDF file information may be transferred to a platform desired for harvesting.

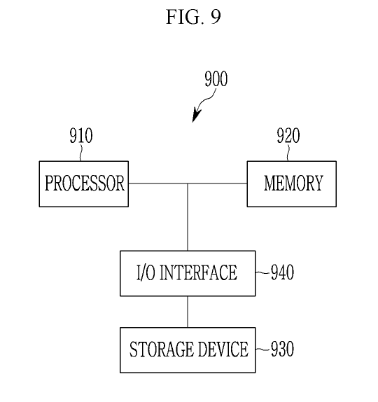

FIG. 9 shows an apparatus for converting metadata according to an embodiment of the present invention.

Referring to FIG. 9, the apparatus for converting the metadata includes a processor 910, a memory 920, a storage device 930, and an input/output (I/O) interface 940.

The processor 910 may be implemented as a central processing unit (CPU) or other chipset, microprocessor, etc.

The memory 920 may be implemented in a medium such as RAM, such as dynamic random access memory (DRAM), rambus DRAM (RDRAM), synchronous DRAM (SDRAM), and static RAM (SRAM), etc.

The storage device 930 may be a hard disk, optical disks such as a compact disc read only memory (CD-ROM), a compact disc rewritable (CD-RW), a digital video disc ROM (DVD-ROM), a DVD-RAM, a DVD-RW disk, blu-ray disk, etc., flash memory, permanent or volatile storage devices such as various forms of RAM.

The I/O interface 940 allows the processor 910 and/or the memory 920 to access the storage device 930. The I/O interface 940 provides an interface for exchanging metadata in a file format between data distribution platforms. The I/O interface 940 may also provide a user interface.

The processor 910 may perform a metadata conversion function described in FIGS. 1 to 8. The processor 910 may load a program command for implementing the metadata conversion function described in FIGS. 1 to 8 into the memory 920 to allow an operation described in FIGS. 1 to 8 to be performed. The program command may be stored in the storage device 930 or stored in other systems connected over a network.

According to the present invention, there is an advantage that data may be exchanged with other data distribution platforms supporting DCAT using a DCAT-based apparatus for converting metadata.

While the present invention has been particularly shown and described with reference to exemplary embodiments thereof, the scope of rights of the present invention is not limited thereto and various modifications and improvements of those skilled in the art using the basic concept of the present invention as defined in the following claims are also within the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for converting metadata in an apparatus for converting metadata, the method comprising:
setting a standard protocol model of the metadata to be applied;
collecting metadata of a distribution platform that is a collection target;
performing mapping between the collected metadata and the standard protocol model; and
converting the mapped metadata into a file format for metadata exchange

2. The method of claim 1, wherein the setting comprises selecting a DCAT (Data Catalog Vocabulary) as a standard protocol.

3. The method of claim 2, wherein the performing of mapping includes:
extracting schema information from the collected metadata;
changing the standard protocol model to a relational model; and
performing mapping on the schema information of the metadata and the relational model.

4. The method of claim 3, wherein the mapping of the schema information of the metadata and the relational model includes mapping if a corresponding field exists in the schema information of the metadata based on the relational model.

5. The method of claim 3, wherein the extracting of the schema information includes extracting the schema and the metadata information using at least one of methods of accessing a database directly, using a REST API that is accessible the database, and accessing a file storing the metadata information.

6. The method of claim 1, wherein the converting includes:
setting an end point; and
determining a file format of the metadata.

7. The method of claim 1, further comprising distributing the metadata converted to the file format.

8. An apparatus for converting metadata of a data distribution platform, the apparatus comprising:
a processor configured to collect metadata of the distribution platform that is a collection target, perform mapping between standard protocol models of the collected metadata and metadata to be applied, and then convert the mapped metadata into a file format for metadata exchange; and
an input/output interface configured to exchange the metadata of the file format.

9. The apparatus of claim 8, wherein the standard protocol model comprises a DCAT (Data Catalog Vocabulary).

10. The apparatus of claim 8, wherein the processor is configured to extract schema information from the collected metadata, change the standard protocol model to a relational model, and then map if a corresponding field exists based on the relational model.

11. The apparatus of claim 10, wherein the processor is configured to extract the schema information using at least one of methods of accessing a database directly, using a REST API that is accessible the database, and accessing a file storing the metadata information.

12. The apparatus of claim 8, wherein the processor is configured to determine an end point for determining an output format of the mapped metadata and then determine a file format of the mapped metadata.
